(19) United States
(12) Patent Application Publication
(10) Pub. No.: US 2007/0224389 A1
(43) Pub. Date: Sep. 27, 2007

(54) Universal insulation plate for use with different insulation substrates and different fasteners

(76) Inventors: Cheryl L. Panasik, Elburn, IL (US); Yongping Gong, Glenview, IL (US); Robert B. Fischer, Roselle, IL (US); S. Riaz Hasan, Palatine, IL (US)

Correspondence Address: Steven W. Weinrieb;SCHWARTZ & WEINRIEB, Crystal Plaza One, Suite 1109, 2001 Jefferson Davis Highway, Arlington, VA, 22202, US

(21) Appl. No.: 11/387,003

(22) Filed: Mar. 23, 2006

(51) Int. Cl. B32B 3/10; B32B 3/30; B32B 9/04

(52) U.S. Cl. 428/131; 428/98; 428/156

(57) ABSTRACT

An insulation plate has a lower height profile, a smaller thickness dimension, and a smaller transverse extent than those of conventional insulation plates so as to effectively reduce the material costs and weight of each insulation plate. In addition, the insulation plate is provided with an increased number of concentric rib members, as compared to conventional insulation plates, whereby the insulation plate is characterized by enhanced rigidity such that the insulation substrate does not achieve pullover with respect to the insulation plate, and wherein further, the radially innermost rib member structurally cooperates with the centrally apertured recessed portion of the insulation plate in order to provide the same with enhanced strength characteristics in order to resist fastener pull-through.

### FIELD OF THE INVENTION

The present invention relates generally to insulation plates which are adapted to be secured at predetermined locations upon an underlying roof decking substructure or system so as to assuredly fix and retain roof decking insulation members or substrates upon the underlying roof decking system or substructure, and more particularly to a new and improved insulation plate wherein the insulation plate has a lower height profile, a smaller thickness dimension, and a smaller diametrical or transverse extent than that of conventional insulation plates so as to effectively reduce the material costs and weight of each insulation plate, and yet, as a result of the insulation plate being provided with an increased number of concentric rib members, as compared to the number of ribs incorporated within conventional insulation plates, the insulation plate exhibits, or is characterized by, enhanced rigidity in order to optimally distribute fixation or retention forces onto the underlying insulation member or substrate in order to assuredly maintain the insulation member or substrate upon the underlying roof decking system or substructure such that the insulation member or substrate does not achieve pullover with respect to the insulation plate, the insulation plate does not experience bending, under, for example, wind uplift forces or conditions, and the radially innermost rib member structurally cooperates with the centrally apertured recessed portion of the insulation plate in order to provide the centrally apertured recessed portion of the insulation plate with enhanced strength characteristics in order to positively resist and prevent fastener pull-through.

### BACKGROUND OF THE INVENTION

Various types of plates are conventionally used in connection with the securing of insulation substrates or members upon underlying roof decking substructures, systems, or assemblies. An exemplary conventional, PRIOR ART insulation plate is disclosed, for example, within United States Patent Application Publication US 2005/0166503 which was published on Aug. 4, 2005 in the name of Panasik. As can be appreciated from FIGS. 1 and 2, which substantially correspond to FIGS. 3 and 4 of the aforenoted published patent application, the insulation plate 310 is seen to have a substantially circular cross-sectional configuration and has a diametrical extent D of approximately three inches (3.00″). The insuation plate 310 also has a centrally located axially downwardly projecting recessed region 314 which annularly surrounds a centrally located aperture 312 through which a fastener is adapted to be inserted in order to secure the insulation plate 310 to the underlying roof decking substructure, and an annular peripheral ledge or flanged edge portion 318. A single, downwardly extending annular rib member 322, or alternatively, a pair of upwardly extending, radially spaced rib members 323,325, are radially interposed between the centrally located aperture 312 and the peripheral edge portion 318, and the insulation plate 310 is seen to have a thickness or profile dimension T, as measured between the upper surface or planar portion UP of the insulation plate 310 and the lower surface or planar portion LP of the downwardly projecting recessed region 314.

In order to achieve or satisfy predetermined pullover requirements, that is, in order to prevent the pullover of the insulation member or substrate with respect to the insulation plate under, for example, predetermined wind uplift conditions, or alternatively, in order to prevent any bending of the insulation plate as caused by means of the insulation substrate or member being subjected to such predetermined wind uplift conditions, the metal material, from which the conventional PRIOR ART insulation plate 310 is fabricated, had to have a predetermined thickness dimension, such as, for example, on the order, or within the range, of eighteen to twenty thousandths of an inch (0.018-0.020″), the resulting conventional PRIOR ART insulation plate 310 had to have the aforenoted thickness or profile dimension T in order to accommodate the headed fasteners which are to be seated within the downwardly projecting recessed region 314 of the insulation plate 310, and the conventional PRIOR ART insulation plate 310 had to have the aforenoted diametrical extent of three inches (3.00″) in order to engage the underlying insulation member or substrate with suitable fixation forces distributed over a predetermined geometrical surface area. The fabrication of such a conventional, PRIOR ART insulation plate 310, having the aforenoted structural features or characteristics, renders such conventional, PRIOR ART insulation plate 310 relatively heavy and costly to manufacture. The relatively heavy weight translates into, or entails, increased shipping or transportation weight and costs, as well as increased weight upon the roofing structure.

A need therefore exists in the art for a new and improved insulation plate wherein the insulation plate can be smaller in its diametrical or transverse extent than that of the conventional PRIOR ART insulation plate, and wherein the insulation plate can be fabricated from metal material which has a smaller thickness dimension than that of the metal material from which the conventional PRIOR ART insulation plate has been fabricated, so as to substantially reduce the weight of each insulation plate as well as the manufacturing costs thereof, wherein further, the insulation plate, despite the fact that it is smaller and thinner than the conventional PRIOR ART insulation plate, will nevertheless satisfactorily engage and secure an underlying insulation substrate or member upon underlying roof decking substructure in such a manner as to effectively permit the underlying insulation member or substrate to satisfactorily resist uplifting wind forces and pullover with respect to the insulation plate, wherein further, the insulation plate will likewise exhibit enhanced pull-through resistance characteristics in connection with the fastener inserted therethrough and fixedly secured within the underlying roof decking substructure, and wherein, still yet further, the centrally located downwardly projecting recessed portion of the insulation plate is located substantially below the undersurface portion of the insulation plate such that not only can the insulation plate be utilized in connection with different types of insulation members or substrates, but in addition, the insulation plate can effectively accommodate differently headed fasteners.

### SUMMARY OF THE INVENTION

The foregoing and other objectives are achieved in accordance with the teachings and principles of the present invention through the provision of a new and improved insulation plate wherein the insulation plate has a diametrical or transverse extent which is less than three inches (3.00″) and preferably is on the order, or within the range, of two and three-quarter inches (2.75″) to two and seven-eighths inches (2.875″. In addition, the insulation plate is provided with three annular reinforcing ribs which not only provide the insulation plate with enhanced rigidity parameters or values within the radially outer portions thereof so as to resist any bending moments that may be impressed thereon by means of the underlying insulation member or substrate under uplifting wind force conditions whereby, in turn, the underlying insulation substrate or member will effectively exhibit enhanced pullover resistance characteristics with respect to the insulation plate. In addition, the reinforcing ribs also provide the insulation plate with enhanced rigidity parameters or values within the radially inner portions thereof so as to effectively reinforce the centrally located, downwardly projecting recessed apertured region of the insulation plate whereby such apertured region of the insulation plate can therefore exhibit enhanced pull-through resistance parameters or values with respect to the fastener disposed therethrough for fixedly connecting the insulation plate to the underlying roof decking substructure.

Accordingly, the insulation plate can be fabricated from a suitable metal material which has a relatively small thickness dimension. The centrally located, downwardly projecting recessed apertured region of the insulation plate also serves to accommodate the head portion of the fastener, which is disposed therethrough for fixedly connecting the insulation plate to the underlying roof decking substructure, whereby the insulation plate is able to be fabricated with a relatively small height or thickness profile so as to be stably seated upon the underlying insulation member or substrate in such a manner as not to adversely affect environmental membranes which will be secured atop the insulation member or substrate in order to protect the same, and the underlying roof decking substructure, from environmental, climatic, or weather conditions. Fabricating the insulation plate from relatively thinner metal material, fabricating the insulation plate so as to have a relatively smaller diametrical or transverse extent, and fabricating the insulation plate so as to have a relatively smaller thickness profile effectively reduces the material costs and weight of each insulation plate. As a result of the aforenoted structure comprising the new and improved insulation plate, the insulation plate may be utilized in conjunction with different insulation members or substrates as well as different fasteners for securing the insulation members or substrates to the underlying roofing deck substructure.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a bottom plan view, of a conventional PRIOR ART insulation plate wherein the insulation plate has a three-inch diametrical extent and comprises a pair of rib members radially interposed between the centrally located apertured portion of the insulation, for accommodating the fastener for securing the insulation plate to the underlying roof decking substructure, and the outer peripheral edge portion of the insulation plate;

FIG. 2 is a cross-sectional view of the conventional PRIOR ART insulation plate as disclosed within FIG. 1 and as taken along lines 2-2 of FIG. 1;

FIG. 3 is a schematic, top perspective view of a first embodiment of a new and improved insulation plate con-structured in accordance with the principles and teachings of the present invention and showing the cooperative parts thereof;

FIG. 4 is a top perspective view of the new and improved first embodiment insulation plate as disclosed within FIG. 3 wherein the new and improved first embodiment insulation plate is shown affixed atop an insulation member or substrate by means of a hexagonally configured headed fastener which is illustrated as being seated downwardly within, and encompassed by, the centrally located downwardly projecting recessed region of the new and improved first embodiment insulation plate;

FIG. 5 is a bottom plan view of the first embodiment insulation plate as disclosed within FIGS. 3 and 4;

FIG. 6a is a bottom perspective view of the first embodiment insulation plate showing the centrally located, downwardly projecting recessed portion of the insulation plate as the same extends beneath the bottom planar surface portion of the insulation plate;

FIG. 6b is a bottom perspective view of a second embodiment insulation plate, also constructed in accordance with the principles and teachings of the present invention, wherein the centrally located recessed portion of the insulation plate is disposed in a coplanar manner with respect to the bottom planar surface portion of the insulation plate;

FIG. 7 is a bottom plan view of the second embodiment insulation plate, as disclosed within FIG. 6b, illustrating the centrally located coplanar recessed portion of the insulation plate;

FIG. 8 is a bottom perspective view, similar to that of FIG. 6a, showing, however, a third embodiment of a new and improved insulation plate, also constructed in accordance with the principles and teachings of the present invention, wherein the centrally located, downwardly projecting recessed portion of the insulation plate comprises an annularly extruded eyelet or ring member extending beneath the bottom planar surface portion of the insulation plate;

FIG. 9 is a cross-sectional view of the new and improved third embodiment insulation plate as disclosed within FIG. 8, and as taken along the line 9-9 of FIG. 8, illustrating the details of the annularly extruded eyelet or ring member comprising the downwardly projecting recessed portion of the third embodiment insulation plate;

FIG. 10 is a schematic view partially illustrating a first variation of the annularly extruded eyelet or ring member comprising the downwardly projecting recessed portion of the third embodiment insulation plate as illustrated within FIG. 9;

FIG. 11 is a schematic view partially illustrating a second variation of the annularly extruded eyelet or ring member comprising the downwardly projecting recessed portion of the third embodiment insulation plate as illustrated within FIG. 9; and

FIG. 12 is a schematic view partially illustrating a third variation of the annularly extruded eyelet or ring member comprising the downwardly projecting recessed portion of the third embodiment insulation plate as illustrated within FIG. 9.

### DETAILED DESCRIPTION OF THE PREFERRED EMBODIMENT

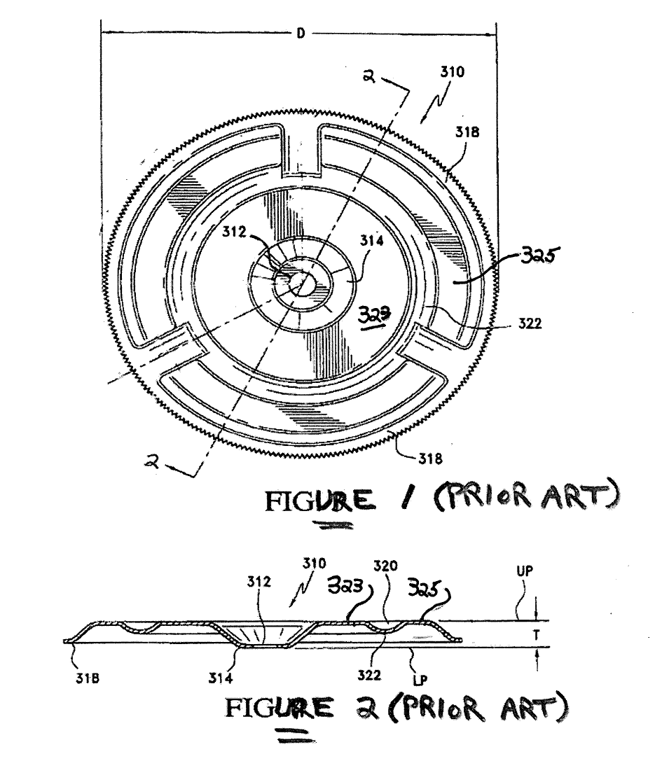

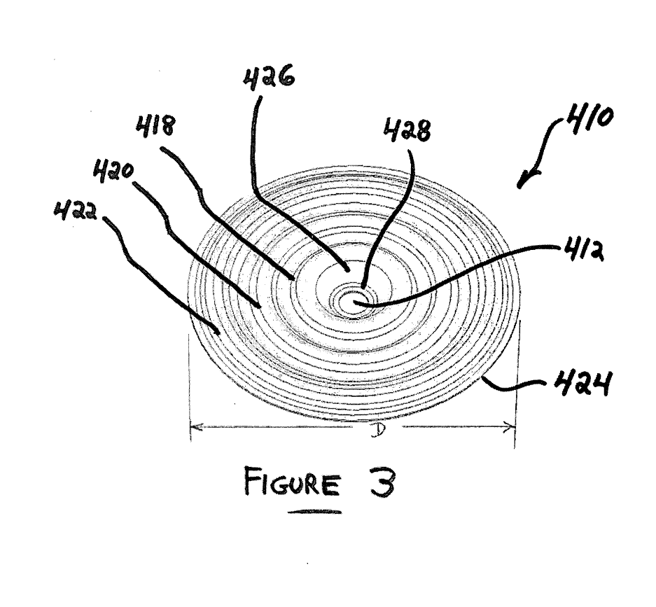

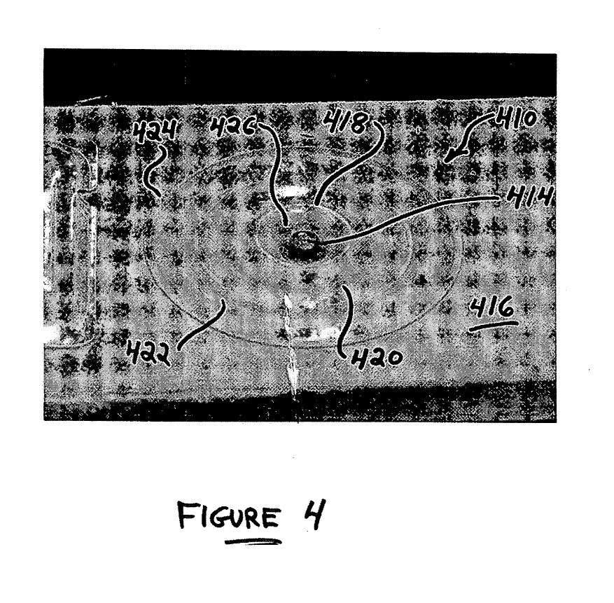

Referring now to the drawings, and more particularly to FIGS. 3-6a thereof, a first embodiment of a new and improved insulation plate, constructed in accordance with the principles and teachings of the present invention, is disclosed and is generally indicated by the reference character 410. More particularly, it is initially seen that the new and improved insulation plate 410 has a circular cross-sectional configuration, although other geometrical configurations, such as, for example, square, or the like, are possible and contemplated. The insulation plate 410 has a centrally located aperture 412 defined therein, through which a suitable threaded bolt type fastener 414, as disclosed within FIG. 4, is adapted to be disposed for fixedly connecting and securing the insulation plate 410 to the underlying roof decking substructure, not shown, in order to, in turn, fixedly secure an insulation member or substrate 416 atop the underlying roof decking substructure. In addition, in accordance with the teachings and principles of the present invention, and contrary to the structure comprising the conventional, PRIOR ART insulation plate 310 as disclosed within the aforenoted patent application publication to Panasik, and as illustrated within FIGS. 1 and 2, wherein the insulation plate 310 effectively had a pair of reinforcing ribs 323,325 defined or formed therein, the insulation plate 410 of the present invention is provided with three, radially spaced, concentrically disposed reinforcing rib members 418,420,422 which are interposed between the centrally located aperture 412 and the radially outer peripheral edge portion 424 of the insulation plate 410. These structural features of the insulation plate 410 of the present invention provide or define factors which affect multiple operational, structural, and fabrication characteristics or parameters of the insulation plate 410.

More particularly, it can be appreciated that by providing the insulation plate 410 with the three annularly or concentrically arranged reinforcing rib members 418,420, 422, in lieu of providing the same with two annularly or concentrically arranged reinforcing rib members as has been the case with conventional PRIOR ART insulation plates, as exemplified by means of the conventional PRIOR ART insulation plate 310 as disclosed within the aforenoted patent application publication to Panasik, the insulation plate 410 is provided with enhanced rigidity parameters or values within the radially outer portions thereof. Accordingly, not only can the insulation plate 410 sufficiently or adequately resist any bending moments that may be impressed thereon by means of the underlying insulation member or substrate 416 under, for example, uplifting wind force conditions, but in addition, as considered from a somewhat opposite operational perspective or point of view, the insulation plate 410 is able to effectively distribute its retention or fixation forces to the underlying insulation member or substrate 416 such that the insulation plate 410 and underlying insulation member or substrate 416 will together effectively define an assembly which will exhibit enhanced pullover resistance characteristics for the underlying insulation member or substrate 416 with respect to the insulation plate 410. In addition, by providing the insulation plate 410 with the aforenoted enhanced rigidity characteristics, the first embodiment insulation plate 410 of the present invention is able to have a diametrical extent D which is less than three inches (3.00″) and is preferably on the order, or within the range, of two and three-quarter inches (2.75″) to two and seven-eighths inches (2.875″). Accordingly, significant or substantial material cost savings, and a significant or substantial reduction in the weight of each insulation plate 410, can be achieved in connection with the fabrication of each one of the insulation plates 410.

Continuing still further, it is to be additionally appreciated that the provision of the three reinforcing ribs 418,420,422 within the insulation plate 410 also provides the insulation plate 410 with enhanced rigidity values or parameters within the radially inner portions of the insulation plate 410 so as to effectively reinforce a centrally located, downwardly projecting, annular recessed region 426 of the insulation plate 410, within which the centrally located aperture 412 is defined, whereby such centrally located, downwardly projecting, annular recessed region 426 of the insulation plate 410, along with the centrally located apertured region 412 of the insulation plate 410, can therefore exhibit enhanced pull-through resistance parameters or values with respect to the fastener 414 disposed therethrough for fixedly connecting the insulation plate 410 to the underlying roof decking substructure, not shown. More particularly, it can be appreciated that in accordance with the first embodiment insulation plate 410 as disclosed within FIGS. 3-6a, the centrally located, downwardly projecting, annular recessed region 426 of the insulation plate 410 effectively comprises a transitional region which integrally interconnects together the first or radially innermost annular rib member 418 of the insulation plate 410 and the centrally located apertured region 412 of the insulation plate 410.

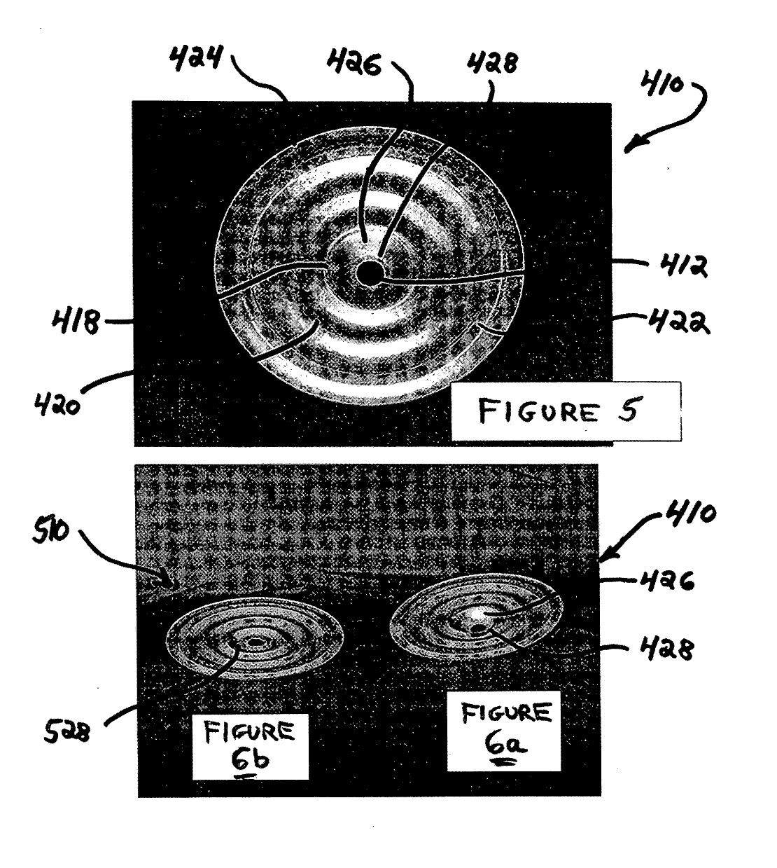

As can best be seen or appreciated from FIG. 6a, the centrally located, downwardly projecting, annular recessed region 426 of the insulation plate 410 has a substantially frusto-conical configuration, and accordingly, it can be appreciated still further that in connection with the enhanced rigidity parameters or values achieved, for example, by means of the three radially spaced, concentrically disposed reinforcing rib members 418,420,422, and in particular, in connection with the centrally located apertured region 412 of the insulation plate 410, the first or radially innermost annular rib member 418 of the insulation plate 410 is located only approximately 0.800 inches (0.800″) from the centrally located apertured region 412 of the insulation plate 410 and therefore effectively serves to readily transmit and concentrate reinforcing force vectors along the substantially steeply sloped side walls comprising the frusto-conically configured centrally located, downwardly projecting, annular recessed region 426 of the insulation plate 410 and toward the centrally located apertured region 412 of the insulation plate 410 so as to effectively reinforce the annularly surrounding wall region of the insulation plate 410 which effectively defines the centrally located apertured region 412 of the insusulation plate 410. In this manner, the centrally located apertured region 412 of the insulation plate 410 is able to exhibit enhanced pull-through resistance properties in connection with the threaded bolt fastener 414 disposed therethrough and fixedly disposed within the underlying roofing deck substructure.

Still yet further, by imparting such enhanced reinforcement and rigidity properties to the frusto-conically configured centrally located, downwardly projecting, annular recessed region 426 of the insulation plate 410, as well as to the centrally located apertured region 412 of the insulation plate 410, in order to achieve the aforenoted enhanced pull-through resistance properties within and characteristic of the frusto-conically configured centrally located, downwardly projecting recessed apertured region 426 of the insulation plate 410, as well as within the centrally located aperture 412 of the insulation plate 410, the insulation plate 410 is able to be fabricated from a sheet of suitable metal material which has a thickness dimension which is within the range of 0.015-0.017 inches. This compares favorably to conventional, PRIOR ART insulation plates which have necessarily been fabricated from thicker sheet metal materials, on the order of, for example, 0.018-0.020 inches, due to the fact that such conventional, PRIOR ART insulation plates must effectively compensate for the fact that they do not have the reinforcing properties characteristic of the insulation plate 410 of the present invention and therefore, the use of thicker sheet metal material, in order to fabricate the insulation plates, is effectively mandated in order to achieve acceptable fastener pull-through resistance properties. As was the case in connection with the reduction in the diametrical extent of the insulation plate 410 of the present invention, as compared to, for example, the diametrical extent of the conventional, PRIOR ART insulation plate 310, a significant or substantial material cost savings, and a significant or substantial reduction in the weight of each insulation plate 410, can be achieved in connection with the fabrication of each one of the insulation plates 410.

Continuing still further, it is additionally noted that the frusto-conically configured, centrally located, downwardly projecting, annular recessed region 426 of the insulation plate 410 projects downwardly beneath the undersurface planar surface portion of the insulation plate 410 by means of a distance which is approximately 0.220 inches (0.220″), and that the transverse width or lateral extent of the bottom surface, terminal end portion 428 of the centrally located, downwardly projecting, annular recessed region 426 of the insulation plate 410 has a dimension which is approximately thirty-five hundredths of an inch (0.350″). These dimensions serve to provide the insulation plate 410 with several advantageous operational factors or features. Firstly, for example, the structure of the frusto-conically configured, centrally located, downwardly projecting, annular recessed region 426 of the insulation plate 410, that is, the frusto-conical config-uration thereof, the depth to which the frusto-conically con-figured, centrally located, downwardly projecting, annular recessed region 426 of the insulation plate 410 projects or extends beneath the undersurface planar surface portion of the insulation plate 410, and the relatively narrow transverse width or lateral extent of the bottom surface, terminal end portion 428 of the centrally located, downwardly projecting, annular recessed region 426 of the insulation plate 410, permits the frusto-conically configured, centrally located, downwardly projecting, annular recessed region 426 of the insulation plate 410 to enter into or compress the insulation member or substrate 416 in a relatively easy manner with minimal distortion or destruction of the insulation member or substrate 416 which would otherwise lead to fracture, cracking, or other deterioration of the insulation member or substrate 416 whereby the pullover resistance characteristics of the insulation member or substrate 416 would be compromised.

In addition, as a result of such relatively easy compression and seating of the frusto-conically configured, centrally located, downwardly projecting, annular recessed region 426 of the insulation plate 410 within the insulation member or substrate 416, the first embodiment insulation plate 410, having the frusto-conically configured, centrally located, downwardly projecting, annular recessed region 426 formed thereon, can be utilized in connection with different types of insulation members or substrates 416, such as, for example, DENSDEK®, ISO (polyisocyanurate), and the like. In particular, it is important that the frusto-conically configured, centrally located, downwardly projecting, annular recessed region 426 of the insulation plate 410 be in fact properly disposed within the upper surface portion of the insulation member or substrate 416, in the aforenoted compression seated manner, such that the undersurface planar surface portion of the insulation plate 410 can in fact be stably seated upon the upper surface portion of the insulation member or substrate 416. Still further, the insulation plate 410 can be utilized in conjunction with different types of bolt-type fasteners, such as, for example, the hex-head type fastener 414 as disclosed within FIG. 4, Phillips head fasteners, and the like.

More particularly, as can readily be appreciated from FIG. 4, even when a relatively high profile hex-head type fastener 414 is utilized in conjunction with the insulation plate 410, the entire head portion of the fastener 414 is disposed within the internally recessed portion of the centrally located, downwardly projecting, annular recessed region 426 of the insulation plate 410 such that the uppermost end portion of the hex-head type fastener 414 does not project above the upper planar surface portion of the insulation plate 410. In this manner, the upper end portion of the hex-head type fastener 414 does not present any abrasive, cutting, or puncturing corner or surface structures to the environmental membranes, not shown but which will subsequently be secured atop the insulation member or substrate 416 in order to protect the same from environmental, climatic, or weather conditions, whereby the structural integrity of the environmental membranes would otherwise be compromised and destroyed. Still yet further, by providing the insulation plate 410 with the particularly structured centrally located, downwardly projecting, annular recessed region 426, which effectively completely houses or accommodates the head portion of the fastener 414, the main body portion of the insulation plate 410, as measured between the upper planar surface and lower planar surface portions thereof, which are respectively defined by means of the upwardly extending crest portions of the rib members 418,420,422, and the downwardly extending trough portions defined and interposed between the rib members 418,420,422, can have a relatively low profile extent, such as, for example, on the order, or within the range, of 0.091 inches (0.091″). Such structural characteristics again result in a significant or substantial material cost savings, and a significant or substantial reduction in the weight of each insulation plate 410, in connection with the fabrication of each one of the insulation plates 410.

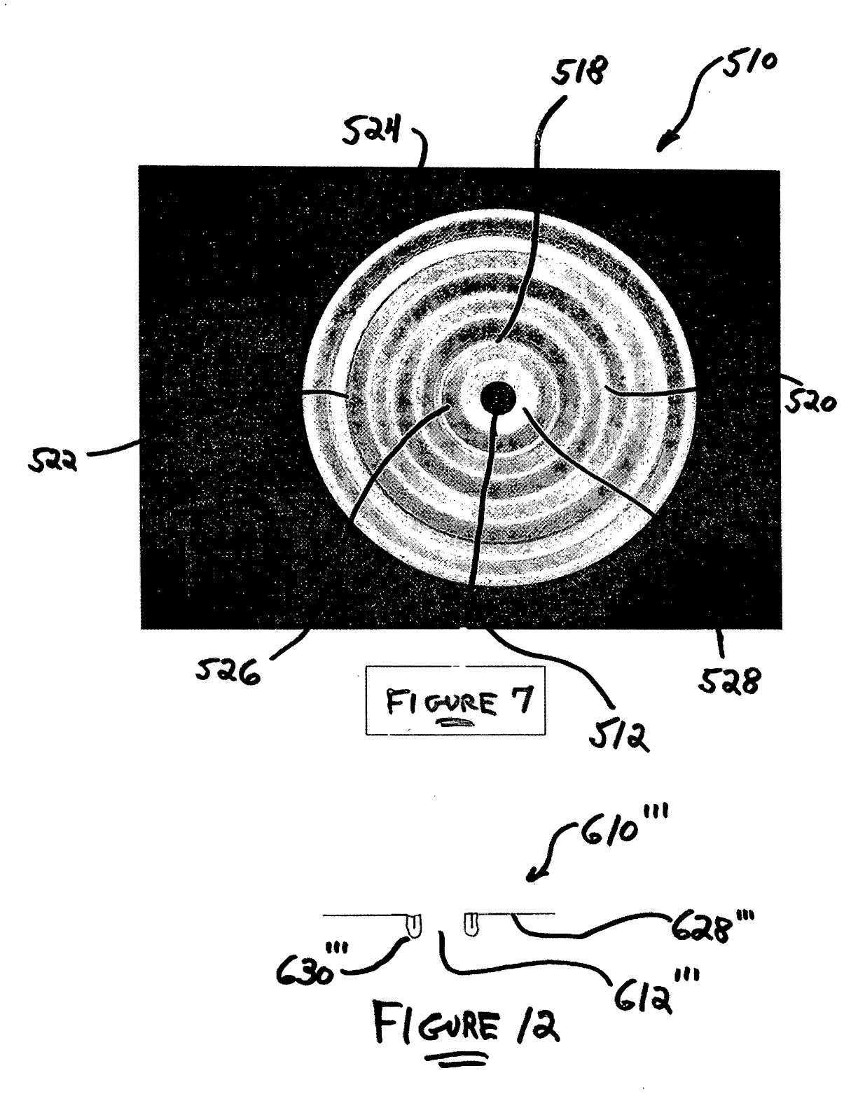

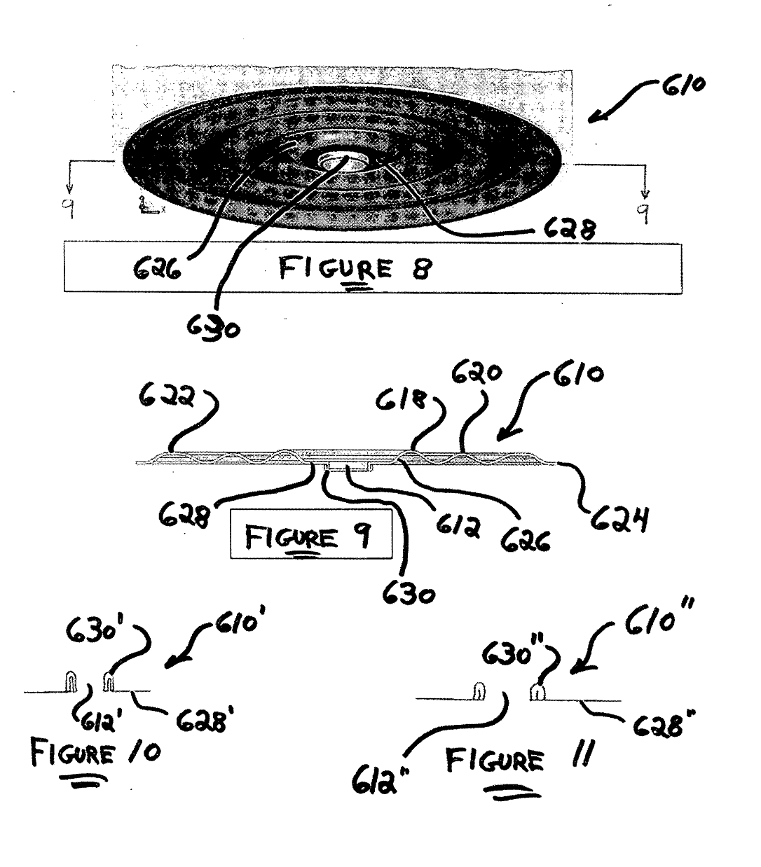

With reference now being made to FIGS. 6b and 7, a second embodiment of a new and improved insulation plate, constructed in accordance with the principles and teachings of the present invention, is disclosed and is generally indicated by the reference character 510. The second embodiment insulation plate 510 is substantially the same as the first embodiment insulation plate 410, except as will be specifically noted hereinafter, and accordingly, a detailed description of the second embodiment insulation plate 510 will be omitted herefrom for brevity purposes, although component parts of the second embodiment insulation plate 510 which correspond to similar component parts of the first embodiment insulation plate 410 will be designated by corresponding reference characters except that they will be within the 500 series. More particularly, it is seen that the only major difference between the second and first embodiment insulation plates 510,410 resides in the fact that the centrally located, downwardly projecting, annular recessed frusto-conically configured transition region 526 of the second embodiment insulation plate 510 is significantly shallower than the centrally located, downwardly projecting, annular recessed frusto-conically configured transition region 426 of the first embodiment insulation plate 410 whereby the bottom surface, terminal end portion 528 of the centrally located, downwardly projecting, annular recessed frusto-conically configured transition region 526 of the second embodiment insulation plate 510 does not project beneath the undersurface planar surface portion of the second embodiment insulation plate 510 but, to the contrary, is disposed in a coplanar manner within the undersurface planar surface portion of the second embodiment insulation plate 510.

The reason for this is that when an insulation plate is to be used in conjunction with an insulation member or substrate which is relatively hard, whereby, for example, the centrally located, downwardly projecting, annular recessed frusto-conically configured transition region 426 of the first embodiment insulation plate 410 would not be able to compress the upper surface portion of the insulation member or substrate so as not to effectively become embedded within the upper surface portion of the insulation member or substrate. In such a case, the second embodiment insulation plate 510 would be utilized whereby the entire second embodiment insulation plate 510 would be seated atop the relatively hard insulation member or substrate, and it is also noted that the bottom surface, terminal end portion 528 of the centrally located, downwardly projecting, annular recessed frusto-conically configured transition region 526 of the second embodiment insulation plate 510 has a larger transverse width dimension than the bottom surface, terminal end portion 428 of the centrally located, downwardly projecting, annular recessed frusto-conically configured transition region 426 of the first embodiment insulation plate 410, and is on the order, or within the range, of one-half inch (0.500″). It is also to be noted that in conjunction with the second embodiment insulation plate 510, in view of the fact that the centrally located, downwardly projecting, annular recessed frusto-conically configured transition region 526 of the second embodiment insulation plate 510 is relatively shallow, unlike the relatively deep centrally located, downwardly projecting, annular recessed frusto-conically configured transition region 426 of the first embodiment insulation plate 410, a low profile threaded bolt-type fastener must be employed in conjunction with the second embodiment insulation plate 510.

With reference now being made to FIGS. 8 and 9, a third embodiment of a new and improved insulation plate, constructed in accordance with the principles and teachings of the present invention, is disclosed and is generally indicated by the reference character 610. The third embodiment insulation plate 610 is substantially the same as the first and second embodiment insulation plates 410,510, except as will be specifically noted hereinafter, and accordingly, a detailed description of the third embodiment insulation plate 610 will be omitted herefrom for brevity purposes, although component parts of the third embodiment insulation plate 610 which correspond to similar component parts of the first and second embodiment insulation plates 410,510 will be designated by corresponding reference characters except that they will be within the 600 series. More particularly, it is seen that in lieu of the simple aperture 612 being formed or defined within the bottom surface, terminal end portion 628 of the centrally located, downwardly projecting, annular recessed frusto-conically configured transition region 626 of the third embodiment insulation plate 610, the through-bore or aperture 612 is actually defined within a downwardly projecting extruded eyelet or ring member 630.

More particularly, as can best be seen from FIG. 9, the eyelet or ring member 630 is seen to have a double-wall thickness construction as a result of the terminal end portion of the eyelet or ring member 630 being folded externally back onto itself whereby the free end portion of the eyelet or ring member encounters the external undersurface portion of the bottom surface portion 628. The significance of this structure resides in the fact that as a result of the provision of such a double-wall thickness construction within the vicinity of, or surrounding, the fastener through-bore or aperture 612, such double-wall thickness construction effectively provides the eyelet structure 630 with enhanced strength and pull-through resistance characteristics with respect to the threaded bolt-type fastener inserted there-through for fixedly securing the insulation plate 610 to the underlying roofing deck substructure. Accordingly, the sheet metal material from which the third embodiment insulation plate 610 is fabricated can be reduced in thickness such that the thickness dimension of the sheet metal material can be approximately 0.013 inches (0.013″). This again serves as a significant reduction in fabrication costs and weight of each insulation plate 610. It is also noted that if it is desired to provide the third embodiment insulation plate 610 and the threaded bolt-type fastener, which is not shown, as a pre-assembled assembly, the eyelet 630 can be formed with a diametrical extent which would effectively define an interference fit with the shank portion of the bolt-type fastener.

With reference now being made to FIG. 10, a first variation of the annularly extruded eyelet or ring member 630 of the third embodiment insulation plate 610 as illustrated within FIG. 9, is illustrated, and it is seen that the first variation eyelet or ring member 630′ is seen to comprise an upwardly extending, internally disposed double-wall thickness construction as a result of the terminal end portion of the eyelet or ring member 630′ being folded internally back into itself and disposed radially inwardly of the integral connection defined between the eyelet or ring member 630′ and the bottom surface portion 628′ of the insulation plate 610′. In a similar but alternative manner, a second variation of the annularly extruded eyelet or ring member 630 of the third embodiment insulation plate 610, as illustrated within FIG. 9, is illustrated within FIG. 11, and it is seen that the second variation eyelet or ring member 630″ is seen to comprise an upwardly extending, internally disposed double-wall thickness construction as a result of the terminal end portion of the eyelet or ring member 630″ being folded internally back into itself and disposed radially outwardly of the integral connection defined between the eyelet or ring member 630″ and the bottom surface portion 628″ of the insulation plate 610″ such that the terminal end portion of the eyelet or ring member 630″ is disposed in engagement with the internal surface portion of the bottom surface portion 628″ of the insulation plate 610″. Lastly, in a still further similar but alternative manner, a third variation of the annularly extruded eyelet or ring member 630 of the third embodiment insulation plate 610, as illustrated within FIG. 9, is illustrated within FIG. 12. More particularly, it is seen that the third variation eyelet or ring member 630′″ is seen to comprise a downwardly extending, externally disposed double-wall thickness construction wherein the terminal end portion of the eyelet or ring member 630′″ is folded internally back into itself such that the terminal end portion of the eyelet or ring member 630′″ is disposed radially inwardly of the integral connection defined between the eyelet or ring member 630′″ and the bottom surface portion 628′″ of the insulation plate 610′″.

Thus, it may be seen that there has been disclosed a new and improved insulation plate wherein the insulation plate has a lower height profile, a smaller thickness dimension, and a smaller diametrical or transverse extent than that of conventional insulation plates so as to effectively reduce the material costs and weight of each insulation plate. In addition, as a result of the insulation plate being provided with an increased number of concentric rib members, as compared to the number of ribs incorporated within conventional insulation plates, the insulation plate exhibits, or is characterized by, enhanced rigidity in order to optimally distribute fixation or retention forces onto the underlying insulation member or substrate in order to assuredly maintain the insulation member or substrate upon the underlying roof decking system or substructure such that the insulation member or substrate does not achieve pullover with respect to the insulation plate, the insulation plate does not experience bending, under, for example, wind uplift forces or conditions, and the radially innermost rib member structurally cooperates with the centrally apertured recessed portion of the insulation plate in order to provide the centrally apertured recessed portion of the insulation plate with enhanced strength characteristics in order to positively resist and prevent fastener pull-through.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters Patent of the United States of America, is:

1. An insulation plate for securing insulation substrates to underlying roof decking substructure, comprising:
an insulation plate member having a peripheral edge portion and a transverse extent of less than three inches (3.00″) so as to reduce the amount of material required to fabricate said insulation plate member;
a through-aperture defined within a central position of said insulation plate member for accommodating a fastener used for securing said insulation member to an underlying roof decking substructure; and
three concentric rib means, formed within said insulation plate member at radially spaced positions interposed between said centrally located through-aperture and said peripheral edge portion of said insulation plate member, for providing said insulation plate member with enhanced bending strength and fastener pull-through properties despite the fact that said insulation plate member has a transverse extent of less than three inches (3.00″).

2. The insulation plate as set forth in claim 1, wherein:
said insulation plate member has a geometrical configuration selected from the group comprising circular and square.

3. The insulation plate as set forth in claim 2, wherein:
said insulation plate member has a circular geometrical configuration; and
said transverse extent of said circular insulation plate member comprises a diameter of less than three inches (3.00″).

4. The insulation plate as set forth in claim 3, wherein:
said diametrical extent of said circular insulation plate member comprises two and three-quarter inches (2.75″).

5. The insulation plate as set forth in claim 3, wherein:
said diametrical extent of said circular insulation plate member comprises two and seven eighths inches (2.875″).

6. The insulation plate as set forth in claim 1, wherein:
said centrally located through-aperture of said insulation plate member is disposed within a downwardly extending recessed region of said insulation plate member.

7. The insulation plate as set forth in claim 6, wherein:
said insulation plate member has an upper planar surface portion, as defined by upwardly extending crest portions of said three rib means, and a lower planar surface portion as defined by downwardly extending trough portions interposed between said three rib means; and
said downwardly extending recessed region of said insulation plate member projects downwardly beneath said lower planar surface portion of said insulation plate member so as to accommodate a high-profile head portion of a fastener, for securing said insulation plate member to the roof decking substructure, disposed within said centrally located through-aperture of said insulation plate member such that the high-profile head portion of the fastener does not project above said upper planar surface portion of said insulation plate member.

8. The insulation plate as set forth in claim 7, wherein:
said downwardly extending recessed region of said insulation plate member, which projects downwardly beneath said lower planar surface portion of said insulation plate member, has a substantially frusto-conical configuration.

9. The insulation plate as set forth in claim 8, wherein:
said downwardly extending, frusto-conically configured recessed region of said insulation plate member projects downwardly beneath said lower planar surface portion of said insulation plate member by means of a predetermined depth dimension of approximately 0.220 inches (0.220″).

10. The insulation plate as set forth in claim 9, wherein:
said downwardly extending, frusto-conically configured recessed region of said insulation plate member, which projects downwardly beneath said lower planar surface portion of said insulation plate member, has a terminal end portion which has a transverse dimension of approximately thirty-five hundredths of an inch (0.350″) whereby said frusto-conically configured recessed region of said insulation plate member can readily compress, and be stably seated within, the insulation substrate.

11. The insulation plate as set forth in claim 6, wherein:
said insulation plate member has an upper planar surface portion, as defined by upwardly extending crest portions of said three rib means, and a lower planar surface portion as defined by downwardly extending trough portions interposed between said three rib means; and
said downwardly extending recessed region of said insulation plate member is disposed in a coplanar manner with said lower planar surface portion of said insulation plate member so as to accommodate a low-profile head portion of a fastener, for securing said insulation plate member to the roof decking substructure, disposed within said centrally located through-aperture of said insulation plate member such that the low-profile head portion of the fastener does not project above said upper planar surface portion of said insulation plate member.

12. The insulation plate as set forth in claim 6, wherein:
said insulation plate member has an upper planar surface portion, as defined by upwardly extending crest portions of said three rib means, and a lower planar surface portion as defined by downwardly extending trough portions interposed between said three rib means; and
said downwardly extending recessed region of said insulation plate member is disposed in a coplanar manner with said lower planar surface portion of said insulation plate member such that the entire lower surface portion of said insulation plate member, comprising said lower planar surface portion as defined by downwardly extending trough portions interposed between said three rib means and said downwardly extending recessed region of said insulation plate member disposed in said coplanar manner with said lower planar surface portion of said insulation plate member, can be stably seated upon an upper surface portion of the insulation substrate.

13. The insulation plate as set forth in claim 1, wherein:
said insulation plate member has an upper planar surface portion, as defined by upwardly extending crest portions of said three rib means, and a lower planar surface portion as defined by downwardly extending trough portions interposed between said three rib means; and
the distance defined between said upper planar surface portion of said insulation plate member and said lower planar surface portion of said insulation plate member, is approximately 0.091 inches (0.091″) such that said insulation plate member has a relatively low profile.

14. The insulation plate as set forth in claim 1, wherein:
said insulation plate member is fabricated from sheet metal material having a thickness dimension which is within the range of 0.015-0.017 inches (0.015-0.017″).

15. The insulation plate as set forth in claim 1, wherein:
the radially innermost one of said three concentrically disposed rib means is spaced a predetermined distance of approximately 0.800 inches (0.800″) from said centrally located through-aperture of said insulation plate member.

16. The insulation plate as set forth in claim 1, wherein:
said centrally located through-aperture of said insulation plate member is defined within an eyelet member defined within a centrally located region of said insulation plate member.

17. The insulation plate as set forth in claim 16, wherein:
said eyelet member comprises a double-wall construction.

18. The insulation plate as set forth in claim 17, wherein:
said double-wall construction of said eyelet member defining said through-aperture, for accommodating a fastener for securing said insulation plate member to the underlying roofing deck substructure, defines enhanced pull-through resistance values of said insulation plate member with respect to the fastener for securing said insulation plate member to the underlying roofing deck substructure.

19. The insulation plate as set forth in claim 18, wherein:
as a result of providing said insulation plate member with enhanced pull-through resistance values with respect to the fastener for securing said insulation plate member to the underlying roofing deck substructure, said insulation plate member is able to be fabricated from a sheet metal material which has a thickness dimension of approximately 0.013 inches (0.013″).

20. The insulation plate as set forth in claim 17, wherein:
said double-wall construction of said eyelet member comprises an annular extrusion portion folded over upon itself.
